(19) United States
(12) Patent Application Publication
(10) Pub. No.: US 2019/0048638 A1
(43) Pub. Date: Feb. 14, 2019

(54) METHOD OF DOOR CONTROL WITHOUT HAND CONTACTING AND THE DEVICE CARRYING OUT THIS METHOD

(71) Applicant: EKOTES TRADE spol. s r.o., Zahorany (CZ)

(72) Inventors: Tomas JANDA, Prague 3 (CZ); Frantisek JANDA, Prague 3 (CZ)

(73) Assignee: EKOTES TRADE spol. s r.o., Zahorany (CZ)

(21) Appl. No.: 16/079,263

(22) PCT Filed: Feb. 21, 2017
(86) PCT No.: PCT/IB2017/000137

§ 371 Date: Aug. 23, 2018

(30) Foreign Application Priority Data
Feb. 22, 2016 (CZ) PV 2016-107

(51) Int. Cl. E05F 11/04; E05F 11/22; E05F 11/54

(52) U.S. Cl. CPC E05F 11/04; E05F 1/1016; E05F 11/54; E05F 11/22

(57) ABSTRACT

The method of door control without, hand contact, wherein, when the door leaf is in its stationary closed position, all the energy necessary for automatic opening and subsequent closing the door leaf, initiated by an actuating force, preferably realized by means of a foot lever, is accumulated in an opening and closing mechanism during the actuating action of the controlling mechanism. During the automatic opening, the only acting force is the tension of the opening member, and during the subsequent automatic closing, the only acting force is the tension of the closing member. By means of the bimodal opening and closing mechanism, the tensions of these two members act separately, not against each other.

### TECHNICAL FIELD

This invention relates to door control without contact of the human hand, wherein the door leaf is provided with an opening and closing mechanism and operating mechanism. The invention also relates to a device for performing this method.

### STATE OF THE ART

The prior art has long known locking mechanisms which automatically close the door or gate. These locking mechanisms are usually composed of various springs or even hydraulic systems when opening doors or gates to accumulate some energy expended to open doors or gates, which is then used to automatically shut these doors or gates. Said closing mechanisms are often provided with damping elements to prevent slamming of the door. These closing mechanisms, inter alia, for example equipping doors in public spaces such as public welfare facilities, in order to ensure automatic closure of areas, for example, public toilets and so on.

Moreover, are also known devices, according to the document US 20090320236 A1 and JPH 0953365 A, which when opening the door by a traditional way by the force of the hand on the door leaf, accumulate part of the energy spent on their opening can not only use their subsequent automatic closure, as well as energy which facilitates their opening, which must be overcome by the force of the closing mechanism. Known it is also a device according to the document JPH02167975A by which again leads to opening of the door conventional manner, wherein when the door is opened halfway, then the door completely open and then with closers completely closed. All of the above devices fail to address the control of another part of the body other than the hands, and the activation is always necessary to move the leaf.

It is also known devices, according to US 20090145037, which allows opening the door closing mechanism provided in the direction of opening against a person using a tension leg or other body part. It is also known a device according to the document US 20130118085 A1, which is located on the door frame a lever mechanism with a spring acting against the force of the closing spring. The disadvantage is that when opening, it is necessary to overcome the force of the closing mechanism. These devices have a major drawback that the operator must simultaneously work force and simultaneously withdraw from the door opening. This complicates the use even in healthy people, disabled people, elderly people or children can not use such a device in practice.

Additionally, there are electrical devices for automatically opening and closing doors, their common drawback is the high cost, the need for power supply. current regular mail. revisions and ensuring el. security in difficult conditions.

That particular problem of public toilets performs transmission of infectious diseases hands of visitors, whose solution can only be practically complete exclusion of hand contact with the door or their fittings, especially when opening the door towards you. The most serious is this problem in a situation where a man coming out of the stall toilet does not have any possibility to perform hand hygiene and must touch the dirty parts. A similar problem occurs in public spaces in general, among which can be counted, for example, fast food places, restaurants and cafeterias, offices, cinemas, concert halls, schools and the like. Inconsiderable, this problem is also in sterile areas such as operating theaters, hospitals, clean production and so on. Finally, the aforementioned problem can occur even in private areas.

The closest known solution to the above problem in this respect is the device for door control according to patent CZ 304,182th In this solution discloses a device wherein the opening mechanism operated by the foot door opening ensures that exerts a force that overcomes the closing mechanism integrated in the door. The solution described in the patent GB 304,182 because of this principle needs to open doors considerable power, and thus it becomes difficult to open the door eg. Children or disabled persons.

The invention is therefore to find a process control doors without contacting the human hand and the structure of the control system a door that, when using the optimized operating force, allowing the automatic opening and closing the door, and also toward each other, without touching the hand of the door leaf.

### SUMMARY OF THE INVENTION

Said task is solved and the drawbacks of the known solutions of this kind are largely eliminated by way of controlling the door without touching the human hand, according to this invention whose principle consists in that the action of an optimized external forces when the door is closed activates simultaneously opening and closing mechanism fitted on the door leaf wherein when opening the door closing mechanism is blocked and when closing the door opening mechanism is blocked, so that the opening and closing force does not act never against each other. The opening and closing mechanism is initiated by the actuating mechanism, which is preferably arranged in the lower region of the door leaf. It is obvious that if a control mechanism to control only the foot, ideally soled shoes passing person shall be a control mechanism arranged in the lower area of the door leaf, preferably even at the lower edge of the door leaf.

Said method controlling the door without contacting the human hand is performed by the device according to the invention whose principle consists in that the door leaf is provided with an opening and closing mechanism mounted preferably on the axis of the hinges of the door leaf, and these mechanisms as a whole are connected with a control mechanism to the lower part of the door leaf.

The control mechanism, which works on a mechanical principle, is arranged in the lower region of the door leaf and enables opening of the door toward and away from each other, using a foot operated tread shoulder.
Another possibility for controlling the doors lies in the fact that the opening and closing mechanism is pneumatic.
The opening and closing mechanism may be preferably a pneumatic-hydraulic.
The opening and closing mechanism may preferably be a hydraulic energy accumulation.
The opening and closing mechanism is provided with a rotary member adapted so that on actuation of the actuating mechanism is rotated either counterclockwise or alternatively in the opening direction of the door leaf 1.
A control mechanism which is arranged in the lower part of the door leaf is provided with a tread shoulder.

A substantial advantage of the invention is that it completely eliminates the need to touch the door leaf by hand, due to which substantially reduces the risk of transmission of infectious diseases and visits as public toilet facilities for visitors pleasant.

The solution described has a number of technical and economic advantages, including the possibility of installation on an existing door leaf and the fact that it is not significantly affected by the function and operation of the door leaf. The device can also be used for locking the door in the open position that can be operated again without touching a human hand. In the event that mounted the opening and closing mechanism through a person apply it works unactivated closing and opening mechanism only as a closer. The entire system is designed to prevent any damage when careless operator.

### COMMENTS TO DRAWINGS

The device will be further illustrated by the drawings and diagrams, in which is described a mechanical solution using torsion springs when opening and closing mechanism is activated by moving the rotatable member against the opening direction of the door.

FIG. 1 is an overall view of the device,

FIG. 2 shows the location of the actuating mechanism on the side of the opening and closing mechanism and placing the tread shoulders and the pivot bearing on the opposite side of the door.

FIG. 3a shows an unactivated state in detail the opening and closing mechanism, FIG. 3b is an unactivated state in detail the opening member, which is realized by a spring and the closure member implemented by a spring, FIG. 3c is a detail latch position in an unactivated state and FIG. 3d shows a detail of the rotary member.

FIG. 4a shows a door closed, the opening and closing mechanism is activated, FIG. 4b is a detail view of the opening member and the closure member and its mounting, FIG. 4c is latched on the plug and FIG. 4d is a detail captured pawl and pawl spring and the carrier.

FIG. 5a shows a general view of the open door. FIG. 5b is a view of the latch just before deactivation when the door leaf with carrier leaves the inertia latch. FIG. 5c shows how the carrier door leaf left latch and the opposite end, a supporting stop on deactivated and the rotary member is in the basic position. FIG. 5d is a detail of the unlocked closure member.

FIG. 6a is a detail of the actuating mechanism in an unactivated state indicating the direction of operating force, and FIG. 6b is a view of a treading activated control mechanism.

FIG. 7a shows a schematic representation of the mechanism where activation occurs by moving the rotatable member against the door opening direction. FIG. 7b shows a schematic representation of the mechanism where activation rotatable member occurs in the direction of movement of the door opening.

### EXAMPLES OF IMPLEMENTATION OF THE INVENTION

Because the invention relates to a control system of one of the door leaf 1, which operates independently of the control system possible second door wing, the invention will be explained in further on clearer example of a single-leaf door.

Regarding the rotatable member 5, this can principally when activating the opening and closing mechanism and rotate both in the opening direction of the door leaf 1, the opposite direction of its opening. In the example embodiment of the invention is disclosed a variant, when the rotary member 5 is rotated upon activation of the upstream door leaf 1.

The control mechanism II can be solved by various technical means. For explanation is used variant stepping lever mechanism to optimize the operating force with stepless automatic change of the transmission ratio according to the invention PV2016-106.

In an example embodiment, the opening member 14 and closing member 17 is implemented by torsion springs.

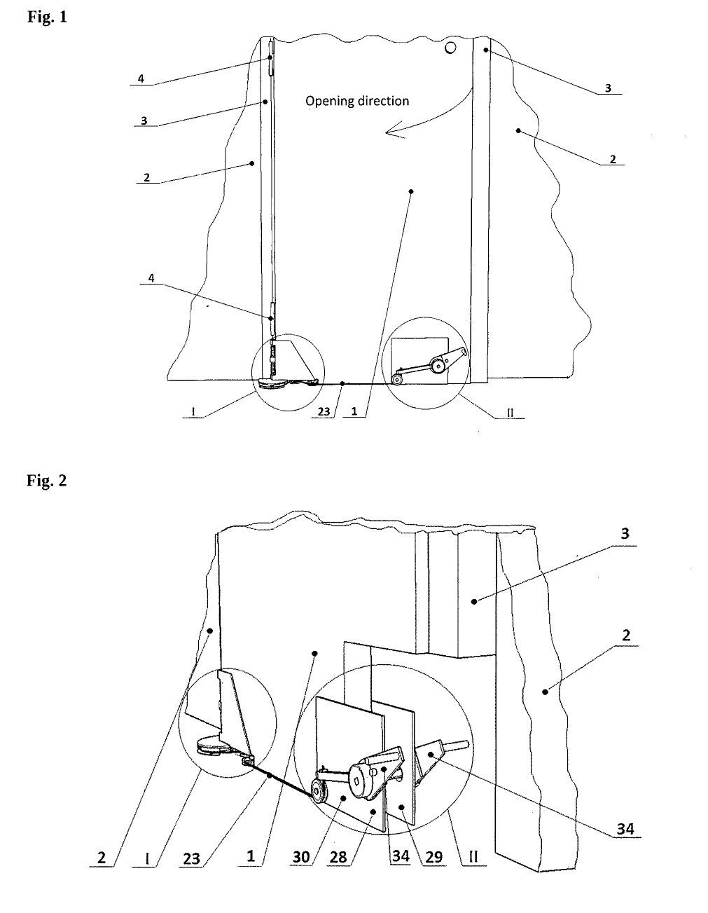

In FIG. 1, which shows an overall view of the device control system of the door according to the invention is evident wall 2, for example, partition between rooms, which can be inserted the frame 3 which is suspended on hinges 4 first door leaf This may be as shown on single doors and double doors also not shown.

The door leaf 1 is provided with an opening and closing mechanism I which can be provided with a commercially available damping. Furthermore, the door leaf 1 is provided with a control mechanism II and a coupling member 23.

In this context it should be noted that it may be either right or left door leaf 1, adjacent at least one of its edges in the closed position on the frame 3, as well as the door leaf 1, the so-called “swinging”, which may be open to both sides of the wall 2 and which with the opening and closing mechanism and itself returns to the closed position, although in this conclusion may temporarily, even repeatedly with decreasing amplitude, accelerate the other side wall of the 2.

Object of the invention, thus enabling opening of the door 1 away from each other and in particular toward and subsequent automatic closure, without the need to touch anything on the door by hand, is solved in that the door leaf 1 is additionally provided with an opening and closing mechanism I, preferably in the lower part of the door leaf 1, which can be activated using the control mechanism, II and connecting member 23, for example by depressing the foot, so that the door leaf 1 before passing person opens and subsequently closes automatically. It is obvious that the opening and closing mechanism and will be held mainly on the side of the door leaf 1, where the door wing 1 opens toward passing a person who would otherwise have had to pull the door leaf 1 to each hand. On the opposite side of the door leaf 1, to which this opens up the passing person, such a control mechanism II necessarily need not be, because the browsing person in this direction could push the door leaf 1 foot, calf, shoulder, elbow, knee, orthopedic aids, etc. For uniformity actuated from both sides of the door leaf 1, it is appropriate that the control element A 28 and actuating element B 29 actuating mechanism for optimalization II arranged on both sides of the door leaf 1, as shown in FIG. 2.

The described embodiment of the control system of the door can be designed so that the opening and closing mechanism and the pneumatic-hydraulic, pneumatic, hydraulic energy accumulation.

For several reasons, it may be a perspective purely mechanical structure of the control system of the door, which will be the opening member 14 and closing member 17 is formed of a spring and as a whole be provided as the energy accumulator or energy for opening and closing the door leaf the 1.

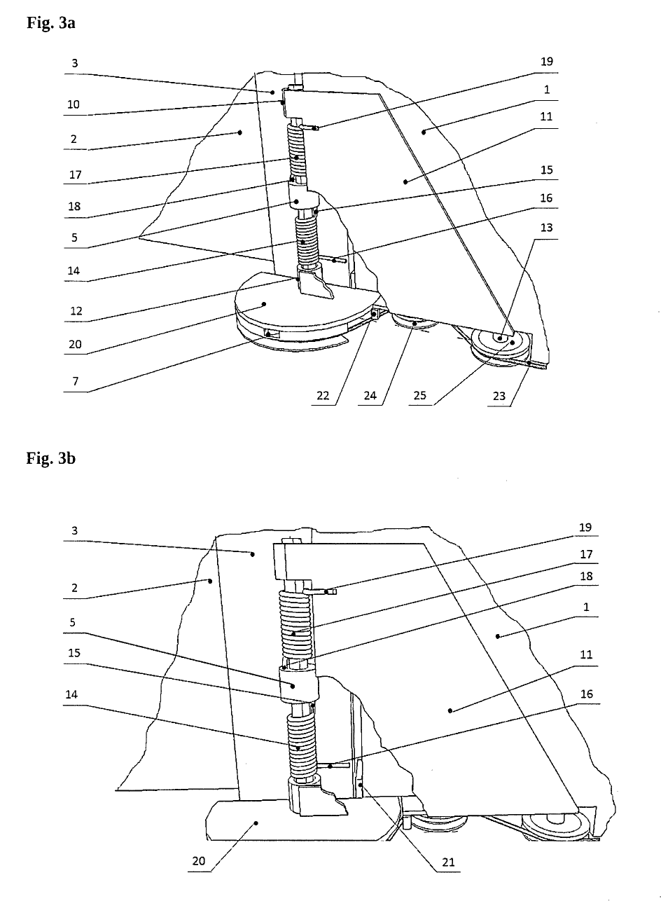

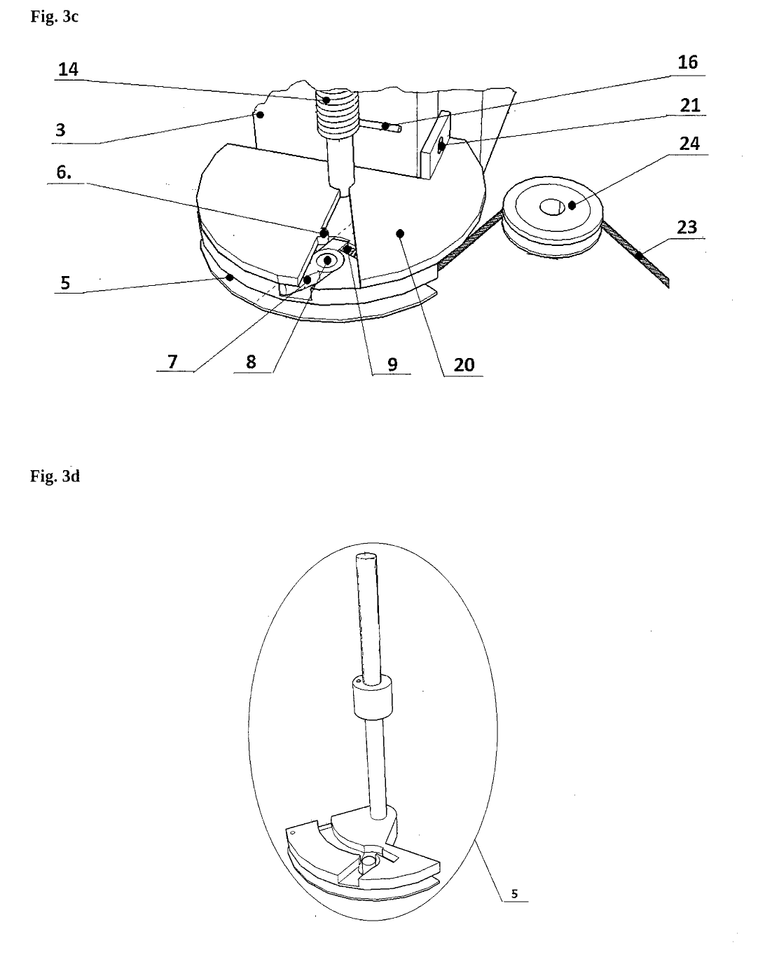

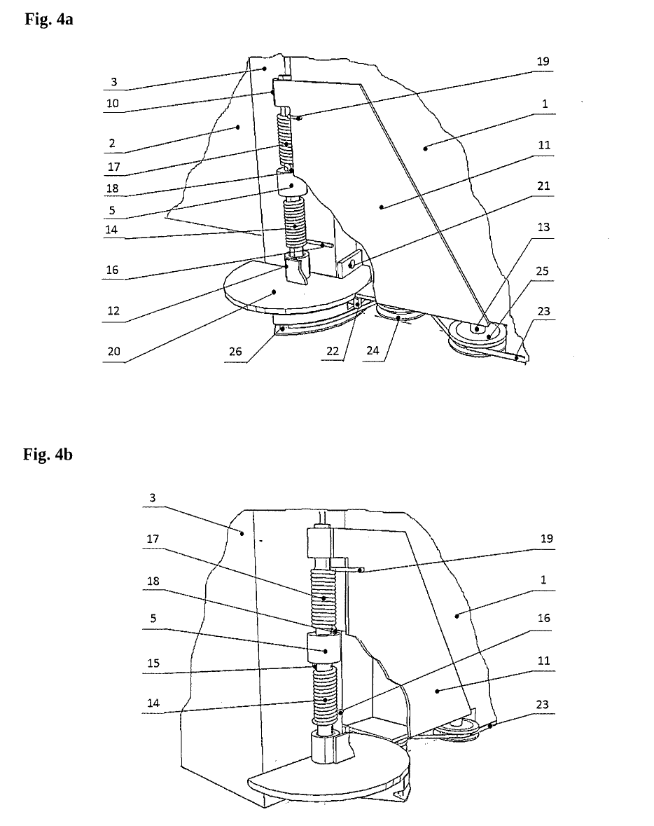

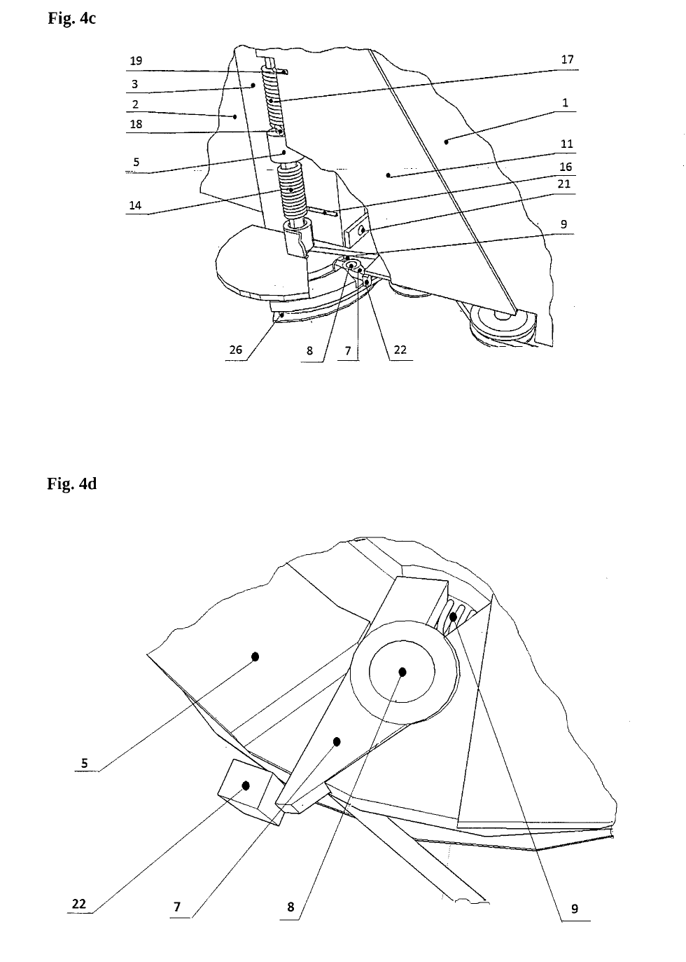

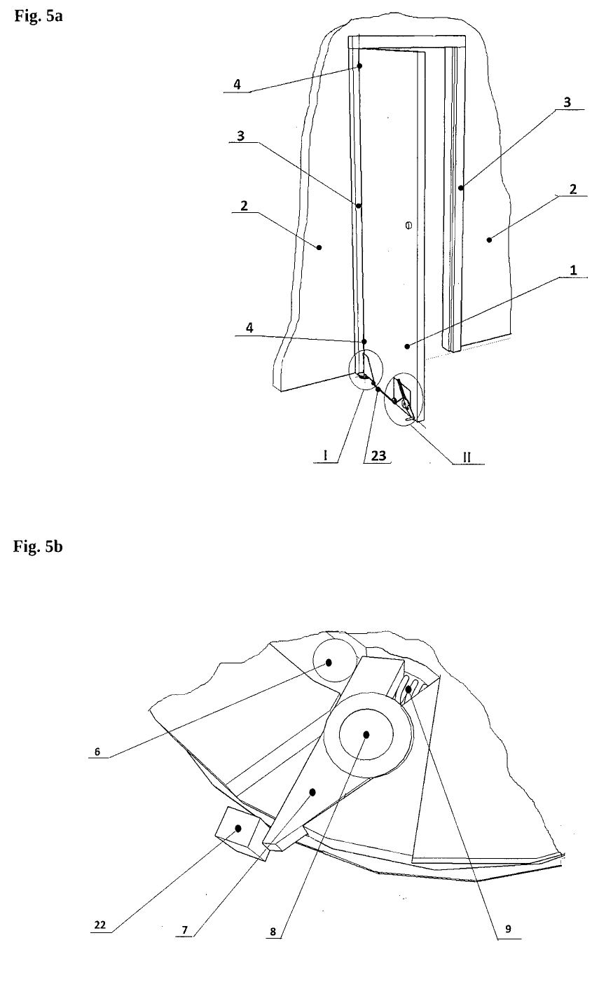

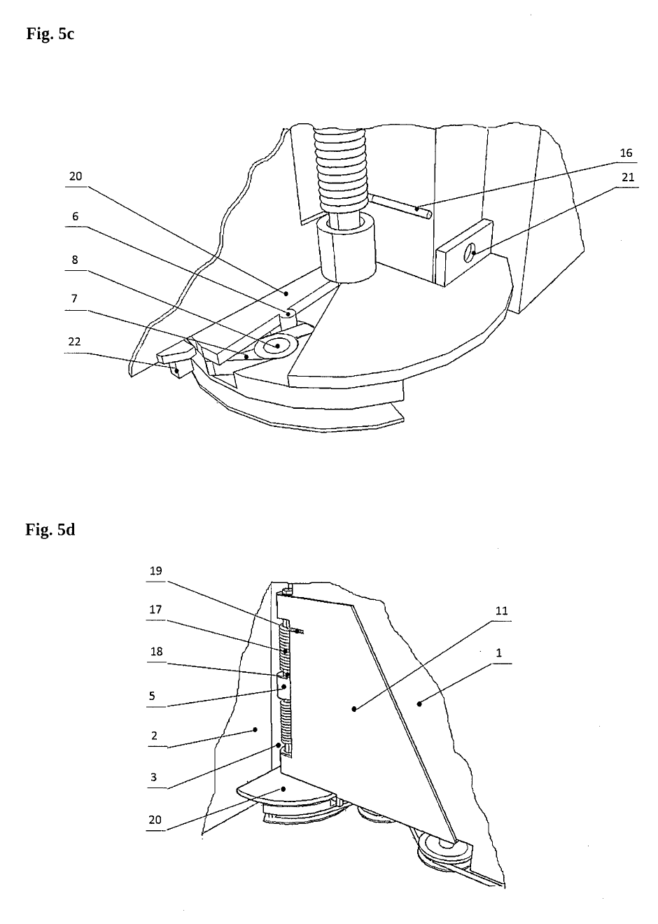

Opening closing mechanism and, according to FIG. 3a consists of the rotation member 5, Which is illustrated in FIG. 3d, made preferably as a rotating section, which is again in the manner of the energy accumulator or energy, when activating control mechanism II with actuating forces 39 about himself contemporary biases member 14 opening and closing member 17—see FIG. 4a. Opening 14 is shown in FIG. 3b, fastened one end using a clamp member 15 of the opening 14 to make the rotating member 5, the other end by an abutment shoulder 16 leaning against the doorframe 3 or directly on the wall of the second closing member 17 is fixed to one end through bracket 18 closing member 17 by making the rotating member 5, the other end by an abutment shoulder 19 the closure member 17 leaning on the handle 11, Which connects the upper hinge 10 and the lower hinge 12, by this on the door leaf 1. Closing member 17 is mounted with a bias for keeping the door leaf 1 in the closed state. Turning the rotary member 5, FIG. 4a will accumulate energy in the opening member 14, in this case twisting of the opening spring is simultaneously accumulates energy in the closing member 17, in this case twisting of the closing spring. After rotating the rotary member 5 does not. The strength of the opening member 14 against the force of the closure member 17. For so can be realized, FIG. 4c, the latch 7, mounted on a pivot point 8, located in the activated state by means of springs 9 of the latch 7, which is in detail shown in FIG. 4d, during rotation of the rotary element 5 captures the yoke 22, Which is secured to the bracket 11 of the lower hinge 10 and the upper hinge 12 and thus on the door leaf 1, FIG. 4a. Tim that each end of the closure member 17 connected to the door leaf 1 When do instant release latches 7, is a function of the closure member 17 is blocked. Opening member 14 acting via a pivotal member 5 carrying a latch 7 to the follower 22 mounted on the bracket 11 of the lower hinge 10a of the upper hinge 12, thus on the door leaf 1, which starts to open, FIG. 4c. Since it must also ensure the mechanical termination of the opening member 14 when fully or almost complete opening of the door 1 that the closing member 17. Could door swing shut again 1, latch 7 rests on its second 6, FIG. 5c. The door leaf 1 together with carrier 22 leaves the inertia of the point of contact with the latch 7, and she was leaning against the stop bolt 7 6 mounted on the cover 20, which is fastened with fixing the cover 21 to the frame 3 or walls 2 returns do disengaged positions. At the door leaf 1 starts to operate unlocked locking member 17 and the doors begin to close automatically. When that yoke 22 mine latch 7 is in disengaged position, FIG. 5c.

Furthermore, the possibility exists that the person passing the door leaf 1 before disengaging the latch 7 withhold, for example feet again. This will ensure that the carrier 22 of the door leaf 1 will not leave inertial force point of contact with the pawl 7, and it thus remains in the activated position, FIG. 5b. The door leaf 1, will then remain in the open position until the operator is, moderate pressure, again such as feet, to door 1, in the direction of its opening, deactivates the latch 7, and thus will cause the closing member 17th same effect can be achieved possibly and moving the door in the closing direction when, after release of the door leaf 1, this will begin to open again and thus inertia to release the latch 7 of the standard method described in the preceding paragraph.
Control mechanism II mechanical embodiment may be arranged on one side of the door leaf 1, while on the opposite side of the door leaf 1 may be on the same axis arranged next tread shoulder 34, FIG. 2 without any additional device so that the opening and closing mechanism I and the whole door wing 1 can be controlled in the same way on both sides. The opening and closing mechanism and is always mounted on the hinge side 4 of the door leaf 1, FIG. 1.

### Function of Description

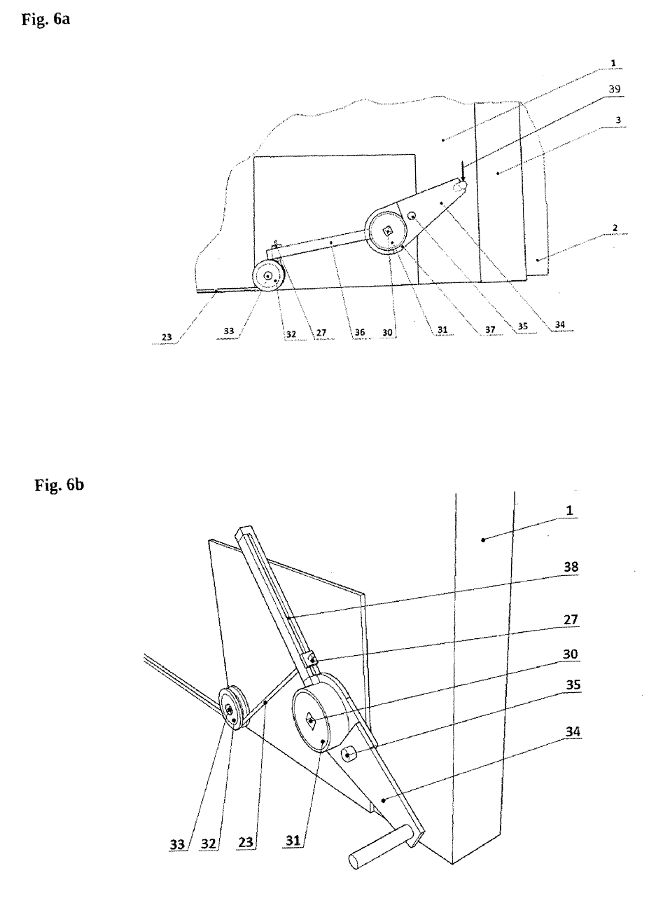

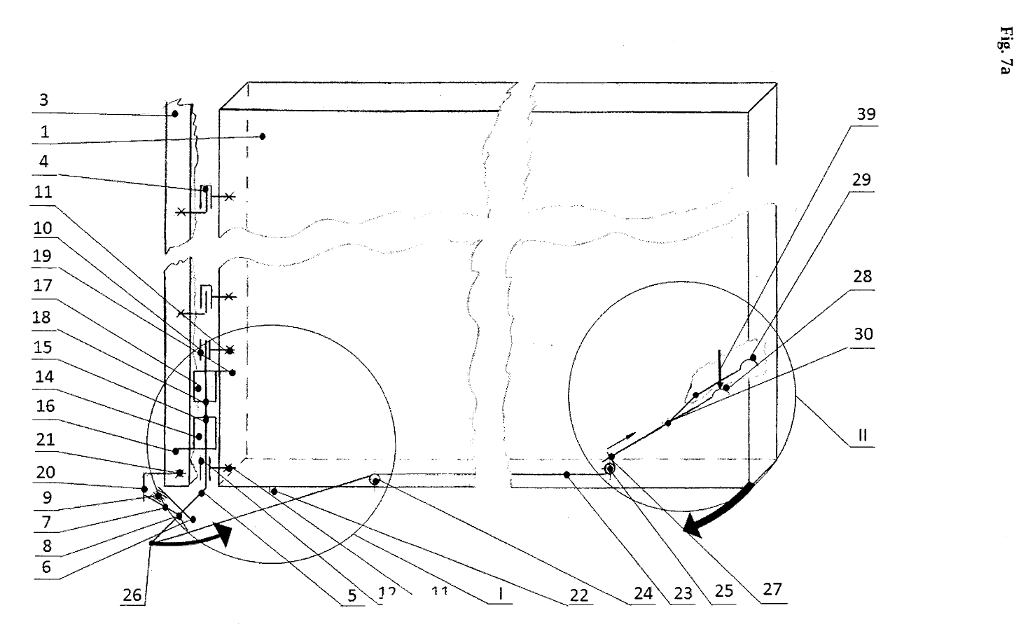

Unactivated condition—FIGS. 1, 2, 3a, 3b, 3c, 3d, 6a, 7a, 7b FIGS. 2 and 6a show the actuating mechanism II, which has a tread shoulder 34, to which an actuating force 39 that pivots about pivot point 30 and is positioned on both sides of the first door wing Pedal arm 34 is connected at its other end with the connecting member 23, guided via a pulley C 32 rotating on a pin 33. a control 28 and control B 29 if it is mounted, are in disengaged, the upper, position and rotatable member 5, whose detail is shown in FIG. 3d is in the position—see FIG. 3a.

Opening member 14 exerts no force. The closing member 17 develops only the preload force to the door leaf 1 kept closed.

Opening member 14 exerts no force. The closing member 17 develops only the preload force to the door leaf 1 kept closed. The latch 7 is in the inactive position, FIG. 3c, as it rests on the stop 6 on the housing 20, attached attachment cover 21 to the frame 3 and the wall 2, due to bias the closure member 17 which overcomes the force of spring 9 latches the seventh opening member 14 does not develop no power or force the biased because its action is blocked by both ends of the frame 3 counteracts or wall 2.

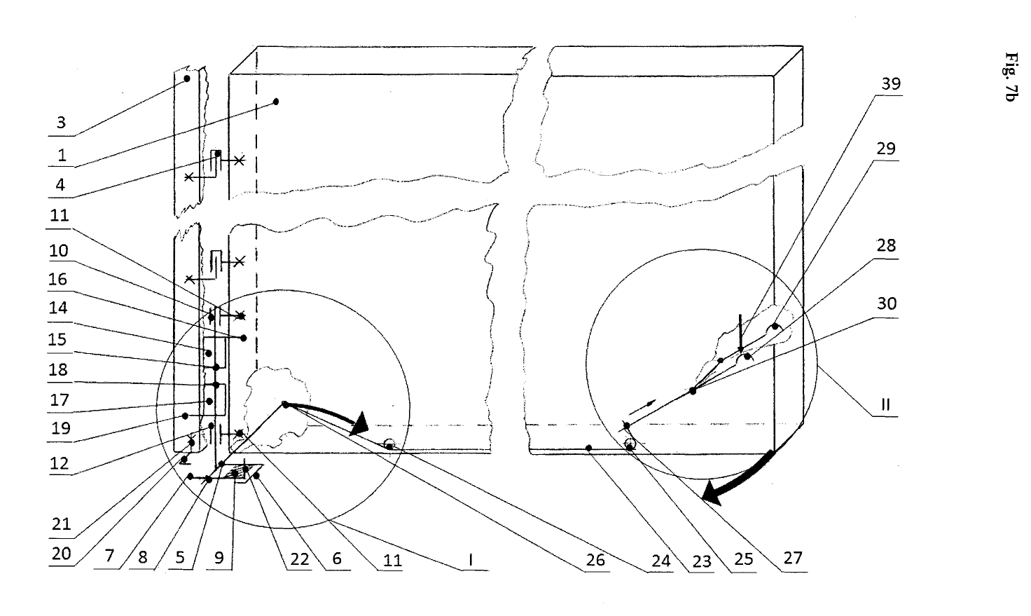

The schematic arrangement is shown in FIG. 7a, which illustrates the operation when opening and closing mechanism and is activated by movement of the rotary member 5 against the direction of opening the first door wing a schematic arrangement in FIG. 7b illustrates the operation when opening and closing mechanism and activates the movement of the rotary member 5 in the same direction as the opening of the door leaf 1.

FIG. 6a shows the control mechanism II in the unactivated state. The connecting member 23, which is guided over a pulley 32 C, rotating on a pin 33 is anchored to the sliding mount 27 of the connecting member 23. The sliding mounting 27 of the connecting member 23 moves along a variable arm 36, depending on the angle of rotation, thereby continuously changing gear which is in the unactivated state is minimal. Pedal arm 34 is mounted on a pivot pin 35 and abutment surface 37 rests on pivot bearing 31st This arrangement prevents possible injury a person is found on the side opposite the operator is that tilting occurs tread shoulders 34.

### Activated State, Door Opening—FIGS. 4a, 4b, 4c, 4d, 6b

Control A 28 and the control B 29 if it is mounted, they are activated, ie lower, position, FIG. 6b and the rotary member 5 is rotated by 90 DEG, FIG. 4a.

Opening member 14 by rotating the rotary member 5 via a twist grip 15 of the opening member 14 and a second end leaning against the abutment arm 16 of opening member 14 of frame 3 and the wall 2 develops full power. The closing member 17 also develops full strength, twisting over the handle 18 of the closure member 17 and by lowering the second end of the supporting leg 19 of the closing member 17 of the door leaf 1, FIG. 4b, but its action is blocked because the both ends counteracts the door leaf 1, FIG. 4c. FIG. 4c is also illustrated attachment 26 of the connecting member 23 to the rotary member 5.

The latch 7 is in the activated position, because he does not rely on the stop 6 and the spring 9 the latch 7 keeps it in the activated state, FIG. 4d. When the motion of the rotary member 5 carrying the pawl 7 for the carrier 22 mounted on the bracket 11 of the lower hinge 10 and the upper hinge 12, the door leaf 1 skips the latch 7 for the carrier 22 and are retained on it, FIG. 4c. Once the person opening the door leaf 1 releases control and control 28 or B 29 and withdraws from the door leaf 1, door leaf 1 begins the opening action of the member 14 open.

FIG. 6b was treading on rotation of the pivot bearing 31 of the tread shoulders 34 about pivot point 30, thereby sliding mount 27 of the connecting member 23 reaches the second extreme position where the transfer is maximal.

### Door Open, Door Closing—FIGS. 5a, 5b, 5c, 5d, 6b

Control A 28 and the control B 29 if it is mounted, are in the activated position, FIG. 5a, FIG. 6b and the rotary member 5 is close to the basic position and deactivating sunsets 7, FIG. 5b. Opening the 14 member develops only residual strength. The closing member 17 develops full power, but its action is blocked because both ends counteracts door leaf 1.

If the door leaf 1 is stopped immediately before the starting position of the rotary member 5, and thereby, the effect of inertia of the door leaf 1 is eliminated, for example by holding legs, the door stays open because of the opening member 14 no longer has sufficient strength to deactivate the latch 7 of the leaning against a stop 6 located on the housing 20 and thus on the frame 3 and the wall 2.

If no stop of the door leaf 1, causing the inertia force of the door leaf 1 together with the carrier 22 leaves the place of contact with the pawl 7, that rests with its other end by a stop 6 located on the housing 20 and thus on the frame 3 and the wall 2 Which deactivates the latch 7 and the rotary member 5, FIG. 5c. This rotary member 5 reaches the initial position.

Opening member 14 exerts no force or strength of the bias, because of its action is blocked by both ends of the frame 3 counteracts or wall 2. The closing member 17 develops the full strength of its action is unblocked in that the end of the latch 7 is based a sixth stop support arm 19 of the closing member 17 acts against the door leaf 1 and the handle 18 of closure member 17, acts on the rotary member 5, and hence to and through the stopper 6 located on the cover 20 to the frame 3 and the wall 2, FIG. 5d.

Deactivating the latch 7 is allowed to the door leaf 1 by treatment effect of the closure member 17 has returned to the closed position.

This solution has a number of technical and economic benefits, including the possibility of installation on an existing door leaf 1 and the fact that it is not fundamentally affected the function and operation of the door leaf 1 in the event that mounted the opening and closing mechanism I is not used, it works unactivated closing and opening 1 only mechanism as a closer.

### INDUSTRIAL APPLICABILITY

The present invention is applicable in all fields where it is necessary to open and close the door in such a way, without touching them human hand because of hygienic reasons, or even in cases where the opening of the hand is difficult, for example if the person opening the door full hand. The usable function is also where it is possible to stop the door in the open position for the passage for example of hospital carriage, for automatic closing of just a light pulse in the direction of opening or closing. Or in other areas where the possibility advantageously use the automatic forward and the return function.

### REFERENCE

I. Opening and closing mechanism

II. The control mechanism
1. Door wing
2. Wall
3. Frame
4. Hinge
5. Rotary member
6. Stop
7. Latch
8. Pivot point latch
9. Latch spring
10. The upper hinge
11. Grip the upper and lower hinge
12. The lower hinge
13. Pin rollers A, B
14. Opening member
15. opening fixture member
16. Member support arm opening
17. Closing member
18. Handle locking member
19. Closing member support arm
20. The cover
21. Fixing the cover
22. Carrier
23. Coupling member
24. A pulley
25. B pulley
26. Gripping connecting member
27. Sliding fit a coupling member
28. A Control
29. B Control
30. Fulcrum
31. Rotatably support
32. Pulley C
33. Pulley bolt C.
34. Tread shoulder
35. The pivot tread shoulders
36. Variable arm
37. The abutment surface of the tread shoulders
38. Variable shoulder groove
39. The actuating force

1. Method of control doors without contacting the human hand in the closed door leaf under the condition that this remains at rest, during the action of actuating force on the actuating mechanism realized preferably Foot shoes accumulates in an opening and closing mechanism, all the energy necessary for automatic opening and subsequent closing of the door leaf, wherein the automatic opening is only acting force strength of the opening member and the subsequent automatic closing is only acting strength of the closing member.

2. Device for performing the process control of the door without touching a human hand according to claim 1, wherein the control mechanism is located on the door leaf, and the door leaf is arranged the opening and closing mechanism comprising an opening member having a first working end is in force transmitting connection with the frame of the door or wall and closing member having a first working end is in force transmitting connection with the door leaf, wherein the second working end of the opening member and a second working end of the closure member are in force transmitting connection with the rotating member actuated actuation mechanism, wherein the rotary member is located the latch, which is both adapted to control the stop connected to the frame or wall and also for engaging the carrier connected to the door leaf, wherein the arrangement provides a frictional connection rotatable member and thereby the second ends of the opening member and closure member so that it is possible to release the accumulated energy is always only one of these members for automatically opening and subsequent closing of the door leaf, wherein the non-member is blocked.

3. Device for performing the process control of the door without touching a human hand according to claim 2, wherein the control mechanism is located on the door leaf, and for the opening member and closing member are preferably formed by a spring.

4. Device for performing the process control of the door without touching a human hand according to claim 2, wherein the control mechanism is located on the door leaf, and the opening and closing mechanism is connected via a connecting member with actuating mechanism which is preferably arranged in the lower part of the door leaf.

5. Device for performing the process control of the door without touching a human hand according to claim 2, wherein the control mechanism is located on the door leaf, the control mechanism which is preferably arranged in the lower part of the door leaf is provided with a tread leg for operating the legs, ideally soled shoes.

6. Device for performing the process control of the door without touching a human hand according to claim 2, wherein the opening and closing mechanism is pneumatic.

7. Device for performing the method door control without contact of a human hand according to according to claim 2, wherein the opening and closing mechanism is a pneumatic-hydraulic.

8. Apparatus for performing the process control of the door without touching a human hand according to according to claim 2, wherein the opening and closing mechanism is a hydraulic energy storage.
